(19) United States
(12) Patent Application Publication
(10) Pub. No.: US 2022/0151433 A1
(43) Pub. Date: May 19, 2022

(54) Heat Deflector Assembly

(71) Applicants: Robert Zurcher, Hemet, CA (US); Irene Zurcher, Hemet, CA (US)

(72) Inventors: Robert Zurcher, Hemet, CA (US); Irene Zurcher, Hemet, CA (US)

(21) Appl. No.: 17/098,514

(22) Filed: Nov. 16, 2020

(51) Int. Cl. A47J 37/07; F24C 14/00; F24C 15/22; F24C 15/00

(52) U.S. Cl. CPC A47J 37/0713; F24C 14/00; A47J 37/0786; F24C 15/005; F24C 15/22

(57) ABSTRACT

A heat deflector assembly for enhancing cleaning gas fired grills includes a plurality of deflectors. Each of the deflectors is comprised of a thermally conductive material such that each of the deflectors can be positioned over a respective one of a plurality of burners in a gas fired grill. Each of the deflectors has a non-stick coating integrated thereon to inhibit has grease from cooking sticking to the deflectors thereby enhancing cleaning grease from the deflectors. A cleaning tool is positionable on a respective one of the deflectors for cleaning the respective deflector. A riser is positionable between a respective burner in the gas fired grill and a grate in the gas fired grill.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to deflector devices and more particularly pertains to a new deflector device for enhancing cleaning gas fired grills.

### (2) Description of Related Art Including Information Disclosed Under 37 CFR 1.97 and 1.98

The prior art relates to deflector devices including a variety of liners that can be positioned in a cooking grill. In at least one instance a non stick coating is applied to the liner. The prior art discloses a method of producing a stick resistant cooking surface with a ceramic coating.

### BRIEF SUMMARY OF THE INVENTION

An embodiment of the disclosure meets the needs presented above by generally comprising a plurality of deflectors. Each of the deflectors is comprised of a thermally conductive material such that each of the deflectors can be positioned over a respective one of a plurality of burners in a gas fired grill. Each of the deflectors has a non-stick coating integrated thereon to inhibit has grease from cooking sticking to the deflectors thereby enhancing cleaning grease from the deflectors. A cleaning tool is positionable on a respective one of the deflectors for cleaning the respective deflector. A riser is positionable between a respective burner in the gas fired grill and a grate in the gas fired grill.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of a heat deflector assembly according to an embodiment of the disclosure.

FIG. 2 is a front view of a deflector of an embodiment of the disclosure.

FIG. 3 is a right side view of an embodiment of the disclosure.

FIG. 4 is a detail view taken from circle 4 of FIG. 2 of an embodiment of the disclosure.

FIG. 5 is a perspective in-use view of an embodiment of the disclosure.

### DETAILED DESCRIPTION OF THE INVENTION

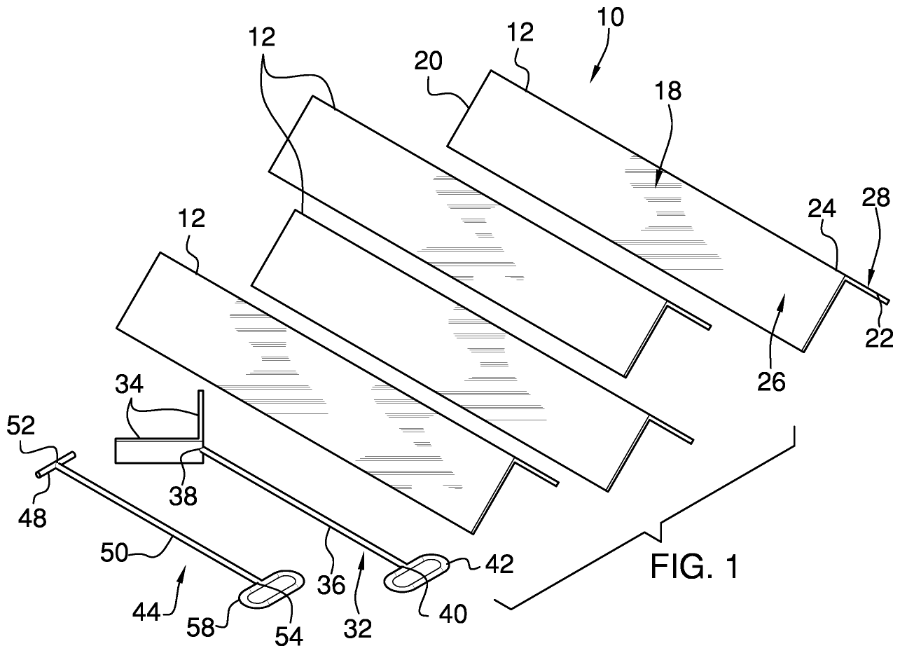

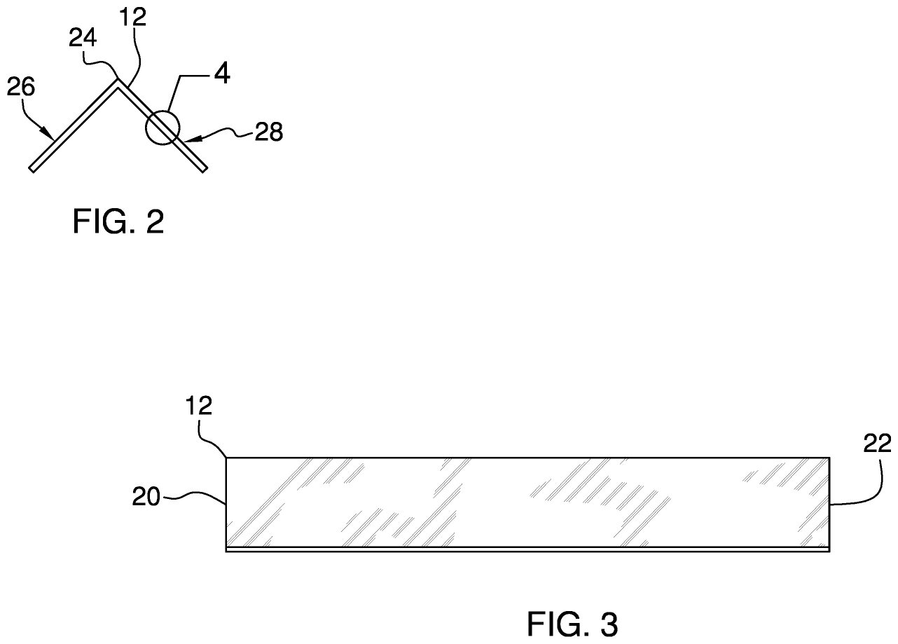

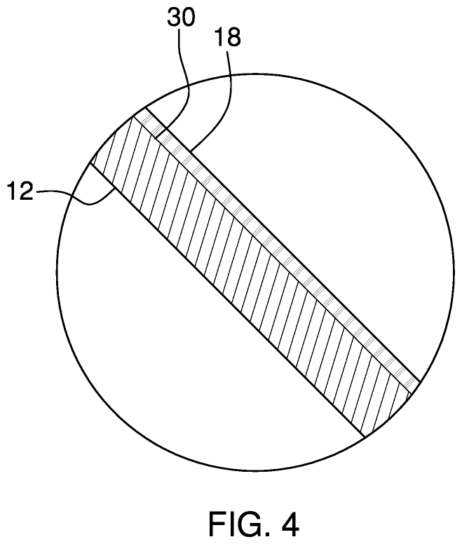

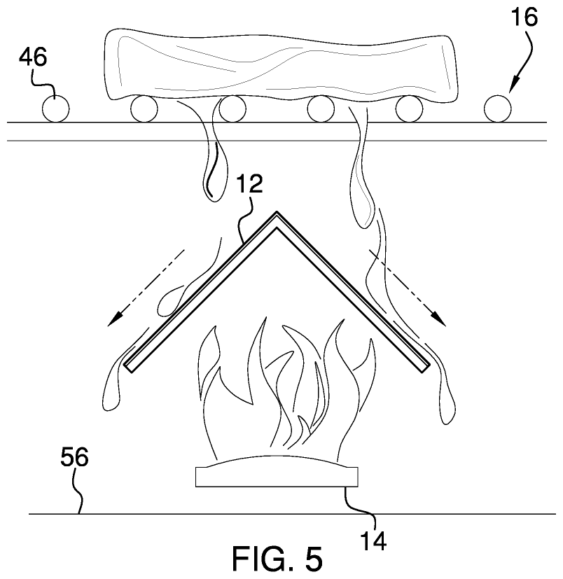

With reference now to the drawings, and in particular to FIGS. 1 through 5 thereof, a new deflector device embodying the principles and concepts of an embodiment of the disclosure and generally designated by the reference numeral 10 will be described.

As best illustrated in FIGS. 1 through 5, the heat deflector assembly 10 generally comprises a plurality of deflectors 12 that is each comprised of a thermally conductive material, such as steel, aluminum or other similar metallic material that can withstand temperatures of at least 500.0 degrees Fahrenheit. In this way each of the deflectors 12 can be positioned over a respective one of a plurality of burners 14 in a gas fired grill 16. The gas fired grill 16 may be a propane grill or other type of cooking grill the burns a combustible gas for the purposes of cooking. Each of the deflectors 12 has a non-stick coating 18 that is integrated thereon to inhibit has grease, which results from cooking, from sticking to the deflectors 12. In this way the grease can be more easily cleaned from the deflectors 12 as compared to existing deflectors in gas fired grills.

Each of the deflectors 12 has a first end 20, a second end 22 and a bend 24 that extends between the first end 20 and the second end 22. The bend 24 defines a first portion 26 of the deflectors 12 that forms an angle with a second portion 28 of the deflectors 12. In this way each of the deflectors 12 has a chevron shaped cross section taken along a line that extends through the first end 20 and the second end 22. Each of the deflectors 12 is positionable in the gas fired grill 16 such that each of the first portion 26 and the second portion 28 angles downwardly from the bend 24. In this way each of the deflectors 12 can facilitate grease from cooking to run downwardly along each of the first portion 26 and the second portion 28. Additionally, each of the deflectors 12 is sufficiently elongated between the first end 20 and the second end 22 to extend along a full length of the respective burner 14.

Each of the deflectors 12 has a first surface 30 that is directed upwardly when the deflectors 12 are positioned in the gas fired grill 16. Moreover, the first surface 30 of each of the deflectors 12 has the non-stick coating 18 is applied thereto. The non-stick coating 18 associated with each of the deflectors 12 completely covers the first surface 30 of the associated deflector 12. The non-stick coating 18 may comprise polytetrafluoroethylene or other similar material that is commonly employed on non-stick cookware.

A cleaning tool 32 is provided and the cleaning tool 32 is positionable on a respective one of the deflectors 12 for cleaning the respective deflector 12. The cleaning tool 32 includes a pair of angled members 34 and each of the angled members 34 conforms to a respective first portion 26 and the second portion 28 of the respective member. The cleaning tool 32 comprises a rod 36 that has a first end 38 and a second end 40, and the first end 38 is coupled to an intersection between the pair of angled members 34. Moreover, the rod 36 is oriented to extend along an axis which bisects an angle formed by the pair of angled members 34 having the second end 40 of the rod 36 being spaced from the intersection between the pair of angled members 34. The cleaning tool 32 includes a grip 42 that is coupled to the second end 40 of the rod 36 for gripping by a user. The grip 42 is continuously arcuate such that the grip 42 forms a closed loop and the grip 42 is elongated along an axis that is oriented perpendicular to the rod 36 such that the grip 42 has an ovoid shape.

A riser 44 is provided and the riser 44 is positionable between a respective burner 14 in the gas fired grill 16 and a grate 46 in the gas fired grill 16. The riser 44 is elongated to lift the grate 46 above the burner 14 for reducing cooking temperature of the grate 46. The riser 44 comprises a first member 48 and a second member 50 that has a first end 52 and a second end 54. The first end 52 of the second member 50 is coupled to the first member 48 such that the second member 50 is oriented transverse with the first member 48. In this way the first member 48 can lie on a bottom wall 56 of the gas fired grill 16 having the second member 50 being oriented vertically oriented in the gas fired grill 16. The riser 44 includes a ring 58 that is coupled to the second end 54 of the second member 50 to abut the grate 46 thereby facilitating the grate 46 to be lifted upwardly from the bottom wall 56 of the gas fired grill 16.

In use, each of the deflectors 12 is positioned over existing deflectors 12 in the gas fired grill 16. In this way the non-stick coating 18 on each of the deflectors 12 facilitates the grease to be more easily cleaned from the deflectors 12 as compared to the existing deflectors 12 in the gas grill 16. Additionally, the deflectors 12 as claimed in this application may be incorporated into the gas grill 16 during the manufacturing process. The cleaning tool 32 can be employed to remove grease that has collected on each of the deflectors 12. The riser 44 can be positioned beneath the grate 46 in the gas fired grill 16 to lift the grate 46, thereby reducing the cooking heat to which the grate 46 is exposed.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A heat deflector assembly for positioning in a gas fired grill for deflecting grease from burners in the gas fired grill, said assembly comprising:
a plurality of deflectors, each of said deflectors being comprised of a thermally conductive material wherein each of said deflectors is configured to be positioned over a respective one of a plurality of burners in a gas fired grill, each of said deflectors having a non-stick coating being integrated thereon wherein each of said deflectors is configured to inhibit having grease from cooking sticking to said deflectors thereby enhancing cleaning grease from said deflectors;
a cleaning tool being positionable on a respective one of said deflectors for cleaning said respective deflector, said cleaning tool having a pair of angled members, each of said angled members conforming to a respective first portion and said second portion of said respective member;
a riser being positionable between a respective burner in the gas fired grill and a grate in the gas fired grill, said riser being elongated wherein said riser is configured to lift the grate above the burner for reducing cooking temperature of the grate.

2. The assembly according to claim 1, wherein each of said deflectors has a first end, a second end and a bend extending between said first end and said second end to define a first portion of said deflectors forming an angle with a second portion of said deflectors such that each of said deflectors has a chevron shaped cross section taken along a line extending through said first end and said second end.

3. The assembly according to claim 2, wherein each of said deflectors is positionable having each of said first portion and said second portion angling downwardly from said bend wherein each of said deflectors is configured to facilitate grease from cooking to run downwardly along each of said first portion and said second portion.

4. The assembly according to claim 2, wherein each of said deflectors is elongated between said first end and said second end wherein each of said deflectors is configured to extend along a full length of the respective burner.

5. The assembly according to claim 1, wherein each of said deflectors has a first surface being directed upwardly when said deflectors are positioned in the gas fired grill, said first surface of each of said deflectors having said non-stick coating being applied thereto, said non-stick coating associated with each of said deflectors completely covering said first surface of said associated deflector.

6. The assembly according to claim 1, wherein said cleaning tool comprises a rod having a first end and a second end, said first end of said rod being coupled to an intersection between said pair of angled members, said rod being oriented to extend along an axis which bisects an angle formed by said pair of angled members having said second end of said rod being spaced from said intersection between said pair of angled members.

7. The assembly according to claim 6, wherein said cleaning tool includes a grip being coupled to said second end of said rod wherein said grip is configured to be gripped by a user, said grip being continuously arcuate such that said grip forms a closed loop, said grip being elongated along an axis being oriented perpendicular to said rod such that said grip has an ovoid shape.

8. The assembly according to claim 1, wherein said riser comprises:
a first member;
a second member having a first end and a second end, said first end of said second member being coupled to said first member such that said second member is oriented transverse with said first member wherein said first member is configured to lie on a bottom wall of the gas fired grill having said second member being oriented vertically oriented in the gas fired grill; and
a ring being coupled to said second end of said second member wherein said ring is configured to abut the grate thereby facilitating the grate to be lifted upwardly from the bottom wall of the gas fired grill.

9. A heat deflector assembly for positioning in a gas fired grill for deflecting grease from burners in the gas fired grill, said assembly comprising:
a plurality of deflectors, each of said deflectors being comprised of a thermally conductive material wherein each of said deflectors is configured to be positioned over a respective one of a plurality of burners in a gas fired grill, each of said deflectors having a non-stick coating being integrated thereon wherein each of said deflectors is configured to inhibit having grease from cooking sticking to said deflectors thereby enhancing cleaning grease from said deflectors, each of said deflectors having a first end, a second end and a bend extending between said first end and said second end to define a first portion of said deflectors forming an angle with a second portion of said deflectors such that each of said deflectors has a chevron shaped cross section taken along a line extending through said first end and said second end, each of said deflectors being positionable having each of said first portion and said second portion angling downwardly from said bend wherein each of said deflectors is configured to facilitate grease from cooking to run downwardly along each of said first portion and said second portion, each of said deflectors being elongated between said first end and said second end wherein each of said deflectors is configured to extend along a full length of the respective burner, each of said deflectors having a first surface being directed upwardly when said deflectors are positioned in the gas fired grill, said first surface of each of said deflectors having said non-stick coating being applied thereto, said non-stick coating associated with each of said deflectors completely covering said first surface of said associated deflector;
a cleaning tool being positionable on a respective one of said deflectors for cleaning said respective deflector, said cleaning tool having a pair of angled members, each of said angled members conforming to a respective first portion and said second portion of said respective member, said cleaning tool comprising:
a rod having a first end and a second end, said first end of said rod being coupled to an intersection between said pair of angled members, said rod being oriented to extend along an axis which bisects an angle formed by said pair of angled members having said second end of said rod being spaced from said intersection between said pair of angled members; and
a grip being coupled to said second end of said rod wherein said grip is configured to be gripped by a user, said grip being continuously arcuate such that said grip forms a closed loop, said grip being elongated along an axis being oriented perpendicular to said rod such that said grip has an ovoid shape; and
a riser being positionable between a respective burner in the gas fired grill and a grate in the gas fired grill, said riser being elongated wherein said riser is configured to lift the grate above the burner for reducing cooking temperature of the grate, said riser comprising:
a first member;
a second member having a first end and a second end, said first end of said second member being coupled to said first member such that said second member is oriented transverse with said first member wherein said first member is configured to lie on a bottom wall of the gas fired grill having said second member being oriented vertically oriented in the gas fired grill; and
a ring being coupled to said second end of said second member wherein said ring is configured to abut the grate thereby facilitating the grate to be lifted upwardly from the bottom wall of the gas fired grill.
